(19) United States
(12) Patent Application Publication
(10) Pub. No.: US 2007/0007370 A1
(43) Pub. Date: Jan. 11, 2007

(54) Clog resistant spray nozzle

(75) Inventor: Matthew John Roman, Geneva, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Spraying Systems Co., Wheaton, IL (US)

(21) Appl. No.: 11/175,812

(22) Filed: Jul. 6, 2005

(51) Int. Cl. B05B 1/00

(52) U.S. Cl. 239/597; 239/600; 239/601; 239/599; 239/598

(57) ABSTRACT

A one piece metal formed liquid spray nozzle adapted for economical manufacture and clog free usage in contaminated work environments. The nozzle has an integrally formed cylindrical protrusion that extends coaxially from a conical plateau surface disposed between laterally spaced guide walls in a manner that facilitates air flow about the discharge orifice for preventing the undesirable buildup of solids.

Spray nozzles such as used in printing presses can be susceptible to clogging by reason of paper dust and ink that build up and eventually clog the discharge orifice of the nozzle. While proposals have been made for nozzle designs which resist clogging, heretofore they have been relatively expensive and difficult to manufacture.

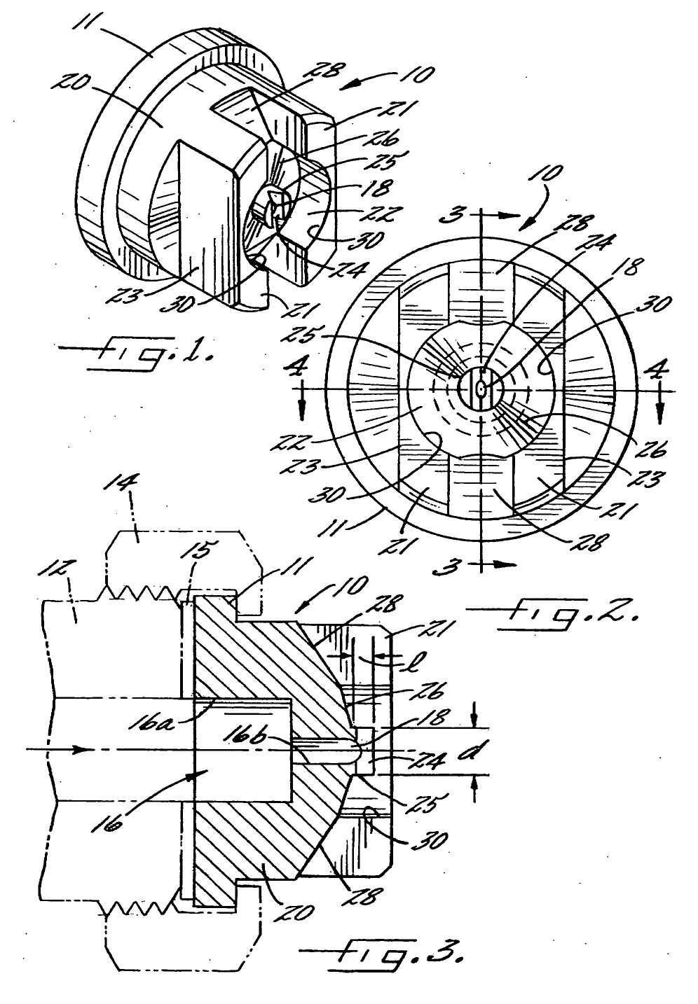

FIG. 3 is a longitudinal section of the illustrated spray nozzle taken in the planes of lines 3-3, in FIG. 2.

While the invention is susceptible of various modifications and alternative constructions, a certain illustrated embodiment thereof has been shown in the drawings and will be described below in detail. It should be understood, however, that there is no intention to limit the invention to the specific form disclosed, but on the contrary, the intention is to cover all modifications, alternative constructions and equivalents falling within the spirit and scope of the invention.

Referring now more particularly to the drawings, there is shown an illustrative spray nozzle 10 in accordance with the invention. The spray nozzle 10 includes an upstream radially extending, annular retaining flange 11 which enables the nozzle to be secured in a conventional manner to an end of a liquid supply line 12 by a retaining clamp 14 with a seal 15 interposed therebetween, as depicted in FIG. 3. The spray nozzle 10 is formed with a liquid flow passage 16 that extends axially through the nozzle, which in this case includes an enlarged upstream passage section 16a and a downstream relatively small nozzling passage section 16b that communicates with a discharge orifice 18 of the spray nozzle.

The illustrated spray nozzle 10 includes a cylindrical body 20 forwardly of the annular retaining flange 11 with a pair of laterally spaced forwardly extending guide walls 21 that define a central spray discharge zone 22 between the side walls 21. The discharge orifice 18 is defined by a cross slot 24 in an axial protrusion 25 centrally within the spray discharge zone 22 for discharging a fan spray pattern. The guide walls 21 are formed with flat outer alignment surfaces 33 in parallel relation to the cross slot 24 for assisting in proper aligned mounting of the spray nozzle 10 for the desired spray application.

In accordance with the invention, the spray nozzle has a one-piece metal construction that is adapted for clog free operation in contaminated environments and which lends itself to economical manufacturer. To this end, the discharge orifice defining protrusion 25 has a cylindrical configuration, which together with other important features of the spray nozzle, permits the spray nozzle to be efficiently and economically manufactured by conventional metal forming procedures. The cylindrical protrusion 25 in this case extends forwardly from a plateau surface 26 that has a domed configuration, which together with the protrusion 25, resists build up of solids and contaminated materials about the discharge orifice 18 of the spray nozzle. The plateau surface 26 in this instance has a conical configuration extending in outward and rearward relation to the protrusion 25. The conical plateau surface 26 communicates with flat tapered side surfaces 28 between opposite outer ends of the guide walls 21. The side surfaces 28 in this case are tapered outwardly and rearwardly at a greater angle to a radial plane than the plateau surface 26. In the preferred embodiment, the cylindrical protrusion 25 has a diameter “d” of between 0.04 and 0.10 inches, and most preferably about 0.085 inches, and extends a distance “I” from the plateau surface 26 a distance between about 0.025 and 0.060 inches, and most preferably about 0.035 inches. While the theory of operation is not entirely understood, it is believed that the tapered side and domed surfaces 28, 26 permit air to communicate more effectively around the cylindrical protrusion 25 on opposite ends of the discharge orifice defining cross slot 24 for preventing the build up of solids and contaminants in the surrounding environment about the end of the protrusion 25, and hence, about the discharge orifice 18.

In keeping with the invention, the guide walls 21 define semi-cylindrical radiused recessed surfaces 30, coaxial with the protrusion 25 and discharge orifice 18, which also can be efficiently manufactured during metal forming operations, and which further facilitate clog resisting air flow about the cylindrical protrusion 25. The cylindrical recessed surfaces 30 of the guide walls 21 preferably have a diameter of at least twice the diameter of the protrusion.

From the foregoing, it can be seen that the spray nozzle of the present invention has a one piece metal clog resistant design that is adapted for relatively easy and economical manufacture by conventional metal forming techniques. The spray nozzle can be effectively used in spraying liquids in contaminated environments for prolonged periods without accumulation of solids about the discharge orifice.

1. A spray nozzle comprising the one piece metallic body and having an axial liquid flow passageway extending between upstream and downstream ends thereof, said body defining an outer plateau surface on a downstream side thereof, said body having a protrusion extending in coaxial relation to said liquid flow passage, said liquid flow passageway communicating with a nozzle discharge orifice defined by a cross slot extending radially through a downstream end of said cylindrical protrusion in intersecting relation with said liquid flow passage, and said protrusion having a cylindrical configuration coaxial with said liquid flow passage and extending in downstream relation to said plateau surface for preventing build up of solid materials about the discharge orifice during usage of the spray nozzle in contaminated environments.

2. A spray nozzle of claim 1 in which said plateau surface extends in outwardly and rearwardly tapered relation to have said cylindrical protrusion.

3. A spray nozzle of claim 2 in which said plateau surface has a conical shape.

4. A spray nozzle of claim 1 in which said nozzle body includes a pair of laterally spaced guide walls on opposite sides of said cylindrical protrusion disposed in parallel relation to said cross slot, and said guide walls defining a pair of recessed radiused surfaces coaxially oriented adjacent opposite sides of said cylindrical protrusion.

5. The spray nozzle of claim 3 in which said conical plateau surface communicates with flat side surfaces disposed between respective opposite outer ends of said guide walls.

6. A spray nozzle of claim 1 in which said cylindrical protrusion has a diameter of between about 0.040 and 0.10 inches and extends a distance of at least 0.025 inches from said plateau surface.

7. The spray nozzle of claim 6 in which said cylindrical protrusion extends a distance of between about 0.025 and 0.040 inches from said plateau surface.

8. The spray nozzle of claim 6 in which said cylindrical protrusion has a diameter of about 0.085 inches.
